(19) United States
(12) Patent Application Publication
(10) Pub. No.: US 2026/0023766 A1
(43) Pub. Date: Jan. 22, 2026

(54) INFORMATION PROCESSING METHOD AND INFORMATION PROCESSING APPARATUS

(71) Applicant: Fujitsu Limited, Kawasaki-shi (JP)

(72) Inventor: Yasuhiko KONDO, Kawasaki (JP)

(73) Assignee: Fujitsu Limited, Kawasaki-shi (JP)

(21) Appl. No.: 19/245,484

(22) Filed: Jun. 23, 2025

(30) Foreign Application Priority Data
Jul. 16, 2024 (JP) 2024-113094

(51) Int. Cl. G06F 16/3329; G06F 40/40

(52) U.S. Cl. CPC G06F 16/33295; G06F 40/40

(57) ABSTRACT

An information processing apparatus generates a query text that instructs, in natural language, extraction of a first state transition that satisfies a predetermined condition regarding meanings of states before and after a transition from a data set indicating a series of transitions of states of a plurality of events. Next, the information processing apparatus inputs the query text to a dialogue system that performs a dialogue in natural language using a language model. Then, the information processing apparatus determines that, for each event, information based on whether the first state transition indicated in a response text output by the dialogue system is included in a series of transitions of states of the event is set as a feature of the event.

### CROSS-REFERENCE TO RELATED APPLICATION

This application is based upon and claims the benefit of priority of the prior Japanese Patent Application No. 2024-113094, filed on Jul. 16, 2024, the entire contents of which are incorporated herein by reference.

### FIELD

The embodiments discussed herein relate to an information processing method and an information processing apparatus.

### BACKGROUND

As a technique for efficiently performing machine learning, there is automated machine learning (AutoML) in which a machine learning model is automatically generated using data sets as inputs. In order to obtain a high-performance model using AutoML, it is important to generate features that appropriately represent the characteristics of the data sets.

As a technique related to the generation of such features, for example, a data analysis apparatus has been proposed which effectively narrows down possible features so as to generate effective features at high speed when obtaining the features from a large amount of data. In addition, as a technique related to machine learning, a machine learning method has also been proposed which allows a user to easily determine what kind of future scenario artificial intelligence (AI) assumes to generate outputs. Furthermore, a feature learning method has been proposed in which a feature is added to a feature learning model if a reconstruction error based on a data sample satisfies a threshold. See, for example, the following literatures.
Japanese Laid-open Patent Publication No. 2020-24544
Japanese Laid-open Patent Publication No. 2023-164155
U.S. Patent Application Publication No. 2020/311544

### SUMMARY

In one aspect, there is provided a non-transitory computer-readable storage medium storing a computer program that causes a computer to perform a process including: generating a query text instructing, in natural language, extraction of a first state transition from a data set indicating a series of transitions of states a plurality of events, the first state transition satisfying a predetermined condition regarding meanings of states before and after a transition; inputting the query text to a dialogue system, the dialogue system being configured to perform a dialogue in the natural language using a language model, the language model being configured to output a response using a sentence in the natural language in response to a query using a sentence in the natural language; and determining that, for each event of the plurality of events, information based on whether the first state transition indicated in a response text output by the dialogue system is included in a series of transitions of states of said each event is set as a feature of said each event.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of an information processing method according to a first embodiment;

FIG. 2 illustrates an example of a system configuration according to a second embodiment;

FIG. 3 illustrates an example of hardware of a machine learning system;

FIG. 4 illustrates an example of a data set representing an execution history of state transition processes;

FIG. 5 illustrates a first example of a method of automatically generating features for each process;

FIG. 6 illustrates an example of a problem that would occur in the case where information indicating whether the occurrence frequency of a path is exceptional is used as a feature;

FIG. 7 illustrates a second example of a method of automatically generating features for each process;

FIG. 8 illustrates an example of a problem that would occur in the case where information indicating whether a path traverses a pattern is used as a feature;

FIG. 9 is a block diagram illustrating an example of functions for performing machine learning relating to state transition processes;

FIG. 10 illustrates an example of a method of generating feature information to be used in machine learning targeting state transition processes;

FIG. 11 illustrates an example of category classification of semantically unreasonable patterns;

FIG. 12 is a flowchart illustrating an example procedure for a machine learning process;

FIG. 13 is a flowchart illustrating an example procedure for a feature determination criterion generation process;

FIG. 14 is a flowchart illustrating an example procedure for a process statistics calculation process;

FIG. 15 illustrates an example of a query text based on a feature determination request;

FIG. 16 illustrates an example of a response text;

FIG. 17 illustrates an example of a category classification instruction;

FIG. 18 illustrates an example of a classification result; and

FIG. 19 illustrates an example of feature determination criterion information.

### DESCRIPTION OF EMBODIMENTS

There are cases in which data related to events that each have a plurality of states and transitions between the states is processed in machine learning. One example of such an event involving state transitions is a process that represents the progress states of a task. Such state transitions are able to follow a wide variety of patterns, which makes it difficult to appropriately determine which state transitions to use as features for machine learning.

Hereinafter, embodiments will be described with reference to the drawings. A plurality of embodiments may be combined unless they exclude each other.

### First Embodiment

A first embodiment provides an information processing method capable of easily determining what information is appropriate to use as features representing the characteristics of each event, in cases where a data set indicating the state transitions of events is used in machine learning.

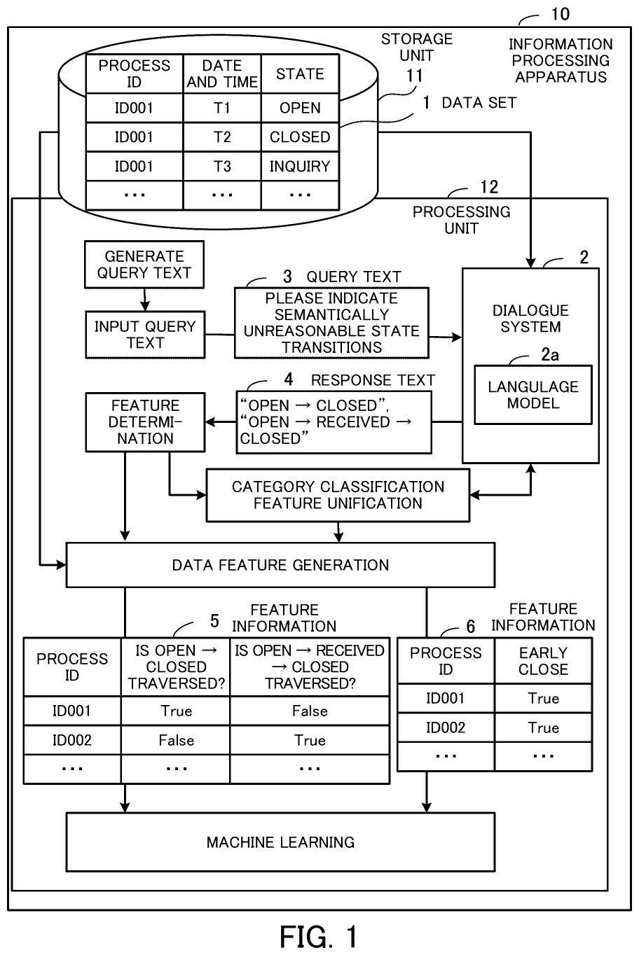

FIG. 1 illustrates an example of an information processing method according to the first embodiment. FIG. 1 illustrates an information processing apparatus 10 for implementing an information processing method according to the first embodiment. The information processing apparatus 10 is able to implement the information processing method according to the first embodiment by, for example, executing an information processing program.

The information processing apparatus 10 includes a storage unit 11 and a processing unit 12. The storage unit 11 is, for example, a memory or a storage device included in the information processing apparatus 10. The processing unit 12 is, for example, a processor or an arithmetic circuit included in the information processing apparatus 10.

The storage unit 11 stores, for example, a data set 1 used in machine learning. The data set 1 indicates a series of transitions of states of a plurality of events. An event is, for example, a process representing the progress state of a task operation. In the case where events are processes, for example, the data set 1 includes, in association with a process ID identifying an executed process, a date and time when the process entered a new state and character information indicating the state.

The processing unit 12 obtains a feature of each of the plurality of events from the data set 1 and performs machine learning. At this time, the processing unit 12 determines appropriate information for use as a feature using a dialogue system 2. The dialogue system 2 performs dialogues in natural language using a language model 2a that receives a query in the form of natural language sentences and outputs a response in the form of natural language sentences in response to the query. The language model 2a is, for example, a machine learning model of a neural network generated by deep learning.

The processing unit 12 generates a query text 3 in natural language for giving a predetermined instruction to the dialogue system 2. The instruction to the dialogue system 2 is an instruction to extract, from the data set 1, first state transitions that satisfy a predetermined condition regarding the meanings of the states before and after a transition. For example, the query text 3 is an instruction to extract state transitions that are not considered to be a normal series of transitions of states for an event in view of the meanings of the states, such as “please indicate semantically unreasonable state transitions”. Then, the processing unit 12 inputs the generated query text 3 to the dialogue system 2.

The processing unit 12 executes the dialogue system 2 to which the query text 3 is input. As a result, the processing unit 12 obtains a response text 4 as a response to the query text 3 input to the language model 2a. In the case where the data set 1 includes a series of transitions of states of task processes, the response text 4 indicates, for example, a state transition “Open→Closed” and a state transition “Open→Received→Closed” as first state transitions. These state transitions are extracted because they are not considered to be normal state transitions as they end without going through a state such as “In Progress” indicating the operation of the task.

The processing unit 12 determines that, for each of the plurality of events, information based on whether a first state transition indicated in the response text 4 output by the dialogue system 2 is included in the series of transitions of states of the event is a feature of the event. For example, the processing unit 12 sets, for each first state transition, information indicating whether the first state transition is included in the series of transitions of states of an event as a feature. For example, information such as “is Open→Closed traversed” and “is Open→Received→Closed traversed” is set as features.

The processing unit 12 generates feature information 5 indicating the features of each of the plurality of events indicated in the data set 1, on the basis of the information based on whether each first state transition indicated in the response text 4 output by the dialogue system 2 is included in the series of transitions of states of an event. For example, if an event (process) traverses the first state transition “Open→Closed”, the processing unit 12 sets the feature “is Open→Closed traversed?” to “True” with respect to the event. If the event (process) does not traverse the first state transition “Open→Closed”, the processing unit 12 sets the feature “is Open→Closed traversed?” to “False” with respect to the event.

The processing unit 12 performs machine learning using the feature information 5. For example, the processing unit 12 generates a model that receives the feature information 5 as an input and outputs abnormal state transitions.

In this way, by inputting the query text 3 relating to the state transitions indicated in the data set 1 to the dialogue system 2 using the language model 2a and obtaining the response text 4, it is possible to easily determine appropriate information as features.

In this connection, the processing unit 12 may include, in the query text 3, information indicating possible states of events such as task processes, for example. For example, the processing unit 12 receives an input of a list of states that events are able to take from a user, and includes the list of states input from the user in the query text 3. Alternatively, the processing unit 12 receives designation of columns in which possible states are set in the data set 1 from the user. Then, the processing unit 12 generates a list of the states set in the designated columns and includes the generated list in the query text 3 as a list of possible states. By including a list of possible states of events such as task processes in the query text 3, the accuracy of a response by the dialogue system 2 is improved.

In addition, the processing unit 12 is able to reduce the number of features used in the machine learning by performing category classification of first state transitions indicated in the response text 4. For example, the processing unit 12 inputs, to the dialogue system 2, a query text 3 instructing an output of a response text 4 including an explanation text of the reason for determining that each first state transition satisfies a predetermined condition. In the case where the response text 4 includes a plurality of first state transitions, the processing unit 12 classifies the plurality of first state transitions into categories based on the explanation texts. Then, the processing unit 12 sets two or more second state transitions classified into the same category among the first state transitions, as a unified feature.

That is, the first state transitions extracted for similar reasons are classified into the same category by the category classification. For example, “Open→Closed” and “Open→Received→Closed” are unified into a category “Early Close” indicating state transitions that are closed early.

In the case where the category classification is performed, the processing unit 12 generates feature information 6 in which a feature is set for each category with respect to each event (process) indicated in the data set 1. In the feature information 6, a feature is set to “True” for an event (process) traversing at least one of two or more second state transitions classified into a category. For an event (process) that does not traverse any of the two or more second state transitions classified into the category, a feature is set to “False”.

By performing the category classification based on the reasons for extracting the first state transitions, the number of features is appropriately reduced.

Note that the processing unit 12 is also able to perform the category classification using the dialogue system 2. For example, the processing unit 12 inputs an instruction for the category classification of a plurality of first state transitions to the dialogue system 2 and acquires the classification result output by the dialogue system 2. In the case where the reliability of responses of the language model 2a is high, the category classification using the dialogue system 2 achieves high accurate category classification.

The processing unit 12 may include, in the query text 3, a statistical value related to a series of transitions of states of a plurality of events indicated in the data set 1. For example, the processing unit 12 obtains, as a statistical value, a series of state transitions (from the beginning to the end) that occur most frequently, a state that occurs most frequently, one or continuous state transitions that occur most frequently, or another, based on the data set 1. Then, the processing unit 12 transmits the query text 3 including the obtained statistical value to the dialogue system 2.

By including such a statistical value in the query text 3 in this manner, the accuracy of determining whether each state transition is set as a first state transition at the time of execution of the dialogue system 2 is improved. For example, it is determined that any state transition included in a series of state transitions (from the beginning to the end) that occur most frequently is not considered to be a semantically unreasonable state transition. As a result, it is possible to prevent an error in which a semantically reasonable state transition is included in the response text 4 as a first state transition in response to the query text 3 “please indicate semantically unreasonable state transitions”.

The processing unit 12 generates the sentences of the query text 3 according to, for example, the purpose of the machine learning. For example, in the case where the purpose is to generate a machine learning model that detects abnormal state transitions, the processing unit 12 sets, as the query text 3, sentences for instructing an output of state transitions that are semantically unreasonable as a normal series of transitions of states for a plurality of events. Alternatively, in the case where the purpose is to generate a machine learning model that detects state transitions that may cause troubles or the like, the processing unit 12 sets, as the query text 3, sentences for instructing, in natural language, extraction of state transitions that need to be carefully monitored.

By generating the query text 3 according to the purpose of the machine learning in this way, it is possible to generate feature information suitable for the purpose of the machine learning and to improve the accuracy of a model generated by the machine learning.

### Second Embodiment

A second embodiment relates to a computer system that automatically generates features for generating a machine learning model, from a data set including execution logs of state transition processes representing the execution flows of tasks.

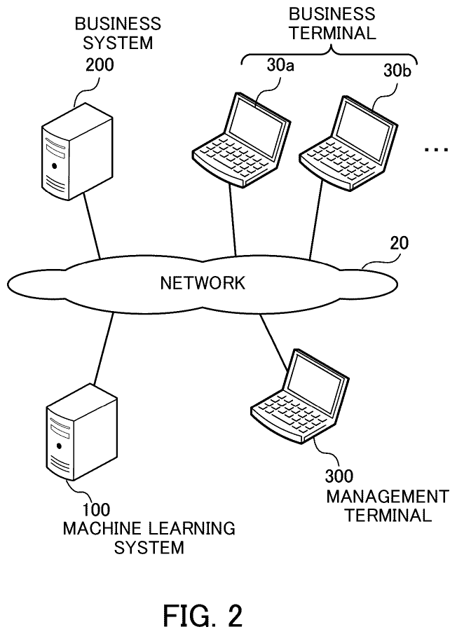

FIG. 2 illustrates an example of a system configuration according to the second embodiment. A machine learning system 100, a business system 200, a management terminal 300, and a plurality of business terminals 30a, 30b, . . . are connected via a network 20.

The machine learning system 100 is a computer that provides services such as generation of a model using machine learning and inference using the generated model. The functions of the machine learning system 100 are provided using, for example, a client computing system. The business system 200 is a computer that manages tasks in an organization such as a company. The management terminal 300 is a computer used by a user who manages the execution of the tasks. The business terminals 30a, 30b, . . . are computers used by users who perform task-related operations, inquiries, and others.

For example, logs of tasks executed using the business terminals 30a, 30b, . . . are stored in the business system 200. The stored logs are usable as a data set that is to be input for training in machine learning or inference. For example, the machine learning system 100 generates a model that detects state transitions that need attention, on the basis of the logs of the tasks, and detects the state transitions that need attention using the model, in order to prevent troubles in tasks in advance.

In the case of performing machine learning, for example, the management terminal 300 transmits a machine learning request for requesting a model generation process using machine learning or an inference process using a trained model, to the machine learning system 100 in response to an instruction from the user. The machine learning request includes a data set to be used in the machine learning.

The machine learning system 100 performs the model generation using machine learning or the inference process using a trained model in response to the machine learning request from the management terminal 300. The machine learning system 100 transmits the processing result to the management terminal 300.

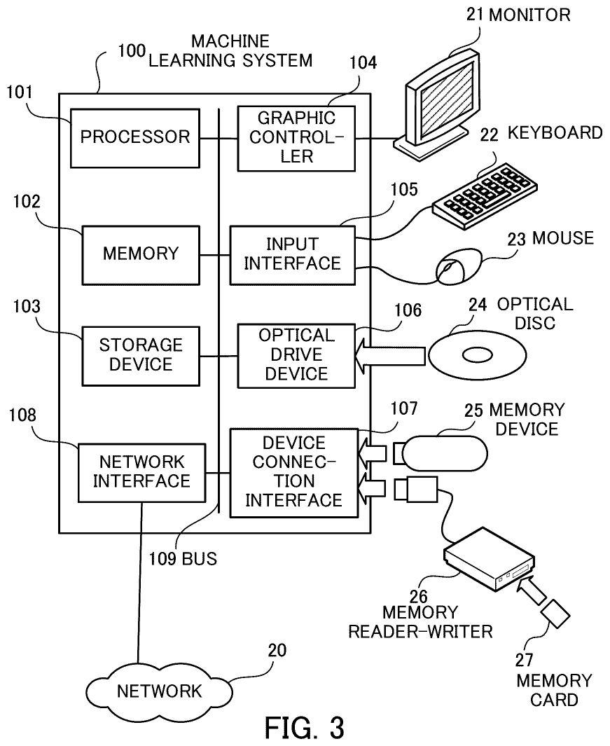

FIG. 3 illustrates an example of hardware of the machine learning system. The entire machine learning system 100 is controlled by a processor 101. A memory 102 and a plurality of peripheral devices are connected to the processor 101 via a bus 109.

The processor 101 may be a multiprocessor. A set of processors in a multiprocessor system may be referred to as the processor 101. The processor 101 may be referred to as processor circuitry. Each of the plurality of processors is able to perform some or all of the plurality of processes performed by the machine learning system 100. Two or more among a plurality of related processes, if there are, may be performed by different processors. The processor 101 is, for example, a central processing unit (CPU), a micro processing unit (MPU), or a digital signal processor (DSP). At least a part of the functions implemented by the processor 101 executing programs may be implemented by an electronic circuit such as an application specific integrated circuit (ASIC) or a programmable logic device (PLD).

The memory 102 is used as a main storage device of the machine learning system 100. The memory 102 temporarily stores at least part of operating system (OS) programs and application programs to be executed by the processor 101. The memory 102 also stores various data used by the processor 101 during processing. As the memory 102, for example, a volatile semiconductor storage device such as a random access memory (RAM) is used.

The peripheral devices connected to the bus 109 include a storage device 103, a graphic controller 104, an input interface 105, an optical drive device 106, a device connection interface 107, and a network interface 108.

The storage device 103 electrically or magnetically writes and reads data to and from a built-in storage medium. The storage device 103 is used as an auxiliary storage device of the machine learning system 100. The storage device 103 stores the OS programs, application programs, and various data. As the storage device 103, for example, a hard disk drive (HDD) or a solid state drive (SSD) may be used.

The graphic controller 104 is an arithmetic device that performs image processing. The graphic controller 104 is, for example, a graphics processing unit (GPU). A monitor 21 is connected to the graphic controller 104. The graphic controller 104 displays images on the screen of the monitor 21 in accordance with instructions from the processor 101. Examples of the monitor 21 include a display device using organic electro luminescence (EL) and a liquid crystal display device. For example, in the case where a GPU is used as the graphic controller 104, the graphic controller 104 is able to perform complex numerical calculations such as matrix calculations.

A keyboard 22 and a mouse 23 are connected to the input interface 105. The input interface 105 transmits signals received from the keyboard 22 and the mouse 23 to the processor 101. The mouse 23 is an example of a pointing device, and other pointing devices may be used. Examples of other pointing devices include a touch panel, a tablet, a touch pad, and a track ball.

The optical drive device 106 reads data recorded on the optical disc 24 or writes data to the optical disc 24 using laser light or the like. The optical disc 24 is a portable storage medium on which data is recorded so as to be readable by reflection of light. The optical disc 24 may be a digital versatile disc (DVD), a DVD-RAM, a compact disc read only memory (CD-ROM), a CD-recordable (CD-R), a CD-rewritable (CD-RW), or the like.

The device connection interface 107 is a communication interface for connecting peripheral devices to the machine learning system 100. For example, a memory device 25 and a memory reader-writer 26 may be connected to the device connection interface 107. The memory device 25 is a storage medium having a function of communicating with the device connection interface 107. The memory reader-writer 26 is a device that writes data to a memory card 27 or reads data from the memory card 27. The memory card 27 is a card-type storage medium.

The network interface 108 is connected to the network 20. The network interface 108 transmits and receives data to and from other computers or communication devices via the network 20. The network interface 108 is a wired communication interface connected to a wired communication device such as a switch or a router via a cable. Further, the network interface 108 may be a wireless communication interface communicatively connected to a wireless communication device such as a base station or an access point by radio waves.

The machine learning system 100 is able to implement the processing functions of the second embodiment with the hardware as described above. The information processing apparatus 10 described in the first embodiment may also be implemented with hardware similar to that of the machine learning system 100 illustrated in FIG. 3.

The machine learning system 100 implements the processing functions of the second embodiment by executing a program stored in a computer-readable storage medium, for example. The program describing the processing content to be executed by the machine learning system 100 may be stored in various storage media. For example, the program to be executed by the machine learning system 100 may be stored in the storage device 103. The processor 101 loads at least part of the program from the storage device 103 into the memory 102 and executes the program. The program to be executed by the machine learning system 100 may be stored on a portable storage medium such as the optical disc 24, the memory device 25, or the memory card 27. The program stored on the portable storage medium becomes executable after being installed in the storage device 103 under the control of the processor 101, for example. Alternatively, the processor 101 may read the program directly from the portable storage medium and execute the program.

In the system as described above, the machine learning system 100 automatically extracts features from a data set of state transition processes when generating a machine learning model. Hereinafter, the difficulty of automatic extraction of features in state transition processes will be described.

The performance of a model generated in machine learning depends on what features are extracted from a data set and used as training data. In many cases, those who are highly familiar with data manually generate features. In order to promote the use of machine learning, it is appropriate to be able to automate the generation of features from data without relying on manpower.

As data used for machine learning, there is a type of data known as point process data. The point process data refers to data that is obtained at irregular time intervals. For example, earthquake data, in which the location, the time of occurrence, and the magnitude are recorded, is point process data. By contrast, data that is acquired at regular time intervals, such as data indicating hourly precipitation in a certain region, is referred to as time-series data. For example, by aggregating the point process data into regular interval data, the point process data may be treated as time-series data

Data that is obtained as logs of state transition processes is also considered to be point process data. Data that may be represented by a state transition process includes, for example, data indicating the state of a task using a computer system. For example, in a state transition process representing the state of a task, the task transitions from a state “Open” indicating the reception of the task, through a state “in progress” or the like, to a state “Closed”. By performing machine learning using data representing such state transition processes, it becomes possible to detect, for example, events that need attention in the course of the task execution, using a trained model.

If appropriate features for solving a machine learning problem are extracted from state transition processes, the machine learning may be performed with high accuracy. However, the transitions between states in the state transition processes are able to follow a wide variety of patterns. Moreover, the terms representing the states in the state transition processes may have a sequential relationship in terms of their meanings, but such semantics are not formally defined.

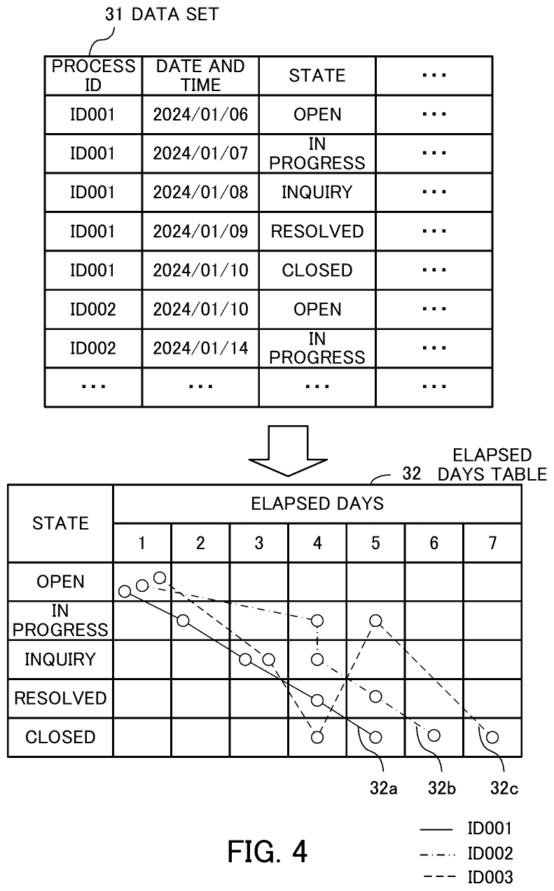

FIG. 4 illustrates an example of a data set representing an execution history of state transition processes. Data set 31 includes a record for each state of the executed processes. Each record includes information such as the process ID of the corresponding process, the date and time of a transition to the corresponding state, the state after the transition, and others. In the example of FIG. 4, there are five possible states for the processes: “Open”, “In Progress”, “Inquiry”, “Resolved”, and “Closed”.

By sorting the records with the same process ID in chronological order based on the date and time, it is possible to confirm the state transitions of the corresponding process. In addition, it is also possible to confirm the state of the process at each elapsed day after the start of the process.

An elapsed days table 32 indicates, for each process in the data set 31, the state corresponding to each elapsed day. A solid polygonal line 32a indicates the state of a process with “ID001” on each elapsed day. A dot-dashed polygonal line 32b indicates the state of a process with “ID002” on each elapsed day. A broken polygonal line 32c indicates the state of a process with “ID003” on each elapsed day.

In the elapsed days table 32, each process begins with the “Open” state and ends with the “Closed” state. However, intermediate states traversed to reach the “Closed” state differ from process to process. In addition, the number of elapsed days before each state transition differs for each process, and the number of elapsed days until reaching the “Closed” state also differs for each process.

In this manner, a process undergoes state transitions as the process progresses. The path of state transitions differs for each process, and the sequential relationship between the states before and after a transition of a process may indicate the characteristics of the process. Here, in order to detect processes that need attention using a machine learning model, it is appropriate that the generation of features from the data set 31 involves extracting features from the data set 31 that are able to distinguish between processes that follow normal state transitions and processes that follow abnormal state transitions.

For example, the process with “ID003” includes the transitions “Closed→In Progress→Closed”. In such a case where the state “In Progress” occurs again even after the state “Closed” is reached once, the sequential relationship of the states is semantically unreasonable. However, such semantically unreasonable state transitions may occur in actual tasks.

Here, state transitions that a process undergoes and that are rearranged in chronological order from oldest to newest are referred to as a “path”. Some continuous state transitions extracted from a single path are referred to as a “pattern”.

For example, the data set 31 includes data relating to processes with process IDs “ID001”, “ID002”, . . . , and others. The path of the process with “ID001” is “Open→In Progress→Inquiry→Resolved→Closed”. Examples of a pattern that may be extracted from the path of the process with “ID001” include “Open→In Progress” and “In Progress→Inquiry→Resolved”.

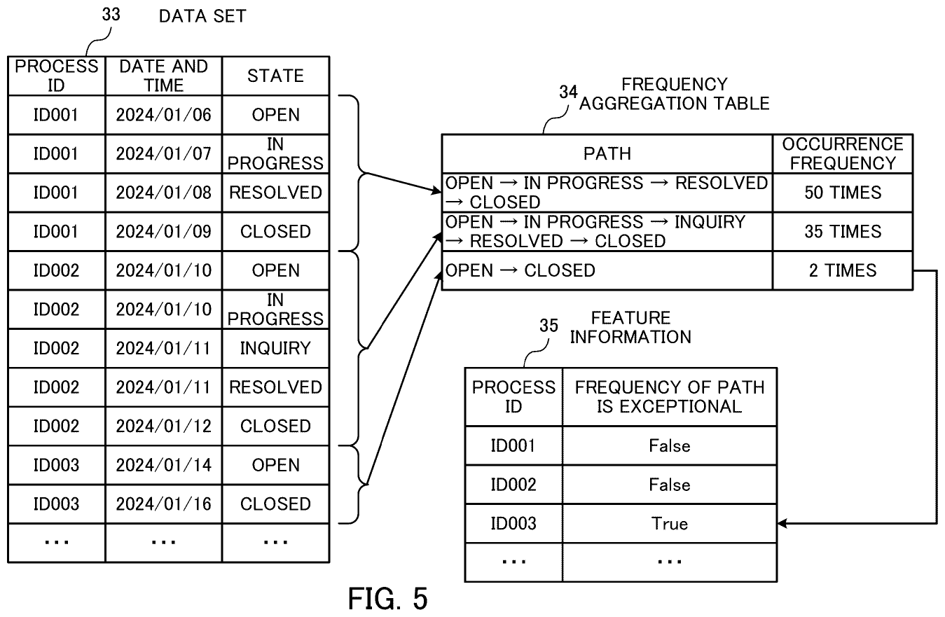

Next, examples of a method of automatically generating features for each process and problems thereof will be described with reference to FIGS. 5 to 8.

FIG. 5 illustrates a first example of a method of automatically generating features for each process. For example, it is conceivable to generate, as a feature, information that distinguishes processes whose paths have a low occurrence frequency from other processes. A frequency aggregation table 34 is obtained by aggregating the state transition paths corresponding to the process IDs from the data set 33. In the frequency aggregation table 34, each path is associated with the occurrence frequency (the number of times) of the path across processes.

For example, the path of the process with “ID001” is “Open→In Progress→Resolved→Closed”. Therefore, “1” is added to the value of the occurrence frequency of the path “Open→In Progress→Resolved→Closed” in the frequency aggregation table 34 according to the path of the process with “ID001”. The path of the process with “ID002” is “Open→In Progress→Inquiry→Resolved→Closed”. Therefore, “1” is added to the value of the occurrence frequency of the path “Open→In Progress→Inquiry→Resolved→Closed” in the frequency aggregation table 34 according to the path of the process with “ID002”. The path of the process with “ID003” is “Open→Closed”. Therefore, “1” is added to the value of the occurrence frequency of the path “Open→Closed” in the frequency aggregation table 34 according to the path of the process of “ID003”.

The frequency aggregation table 34 may include a path with an exceedingly low occurrence frequency. In the example of FIG. 5, the path “Open→Closed” has an occurrence frequency of “2 times”, which is an exceptional occurrence frequency. For each process, information indicating whether the process has a path with an exceptional occurrence frequency may be used as a feature.

For example, feature information 35 associates each process ID with information indicating whether the frequency of the path of the process is exceptional. If the path is an exceptional path, “True” is set. If the path is not an exceptional path, “False” is set. In the example of FIG. 5, the occurrence frequency of the path of the process with “ID003” is exceptional. Therefore, “True” indicating that the frequency of the path is exceptional is set for the process.

However, if information indicating whether the frequency of a path is exceptional is used as a feature, as described above, it is not possible to distinguish between processes whose paths have normal state transitions but a low occurrence frequency and processes whose paths have abnormal state transitions.

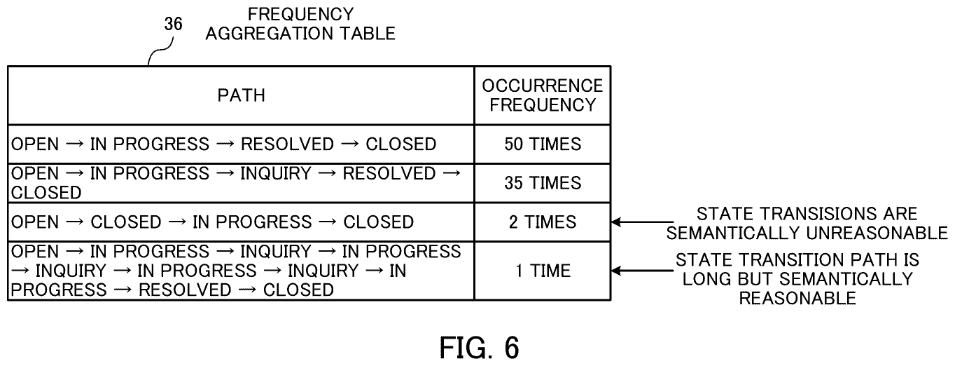

FIG. 6 illustrates an example of a problem that would occur in the case where information indicating whether the occurrence frequency of a path is exceptional is used as a feature. A frequency aggregation table 36 indicates that a path “Open→Closed→In Progress→Closed” has an occurrence frequency of “2 times”, and a path “Open→In Progress→Inquiry→In Progress→Inquiry→In Progress→Inquiry→In Progress→Resolved→Closed” has an occurrence frequency of “1 time”.

In the case where information that distinguishes processes whose paths have a low occurrence frequency from other processes is set as a feature, “True” indicating that the frequency of a path is exceptional is set for a process with the path “Open→Closed→In Progress→Closed”. With respect to this path, the state transitions are semantically unreasonable. That is, considering the meanings of the terms representing the states, it is difficult to explain why the state transitions have occurred under normal circumstances. Therefore, processes having such a path are subjects that need attention.

In addition, “True” indicating that the frequency of a path is exceptional is set for a process with the path “Open→In Progress→Inquiry→In Progress→Inquiry→In Progress→Inquiry→In Progress→Resolved→Closed”. Although the occurrence frequency of this path is low because the number of state transitions is large, the state transitions are semantically reasonable as a whole. That is, this path is a path that may occur as part of a normal operation.

If information indicating whether the frequency of a path is exceptional is used as a feature, processes with paths in which the state transitions are semantically reasonable have the same feature as processes with paths in which the state transitions are semantically unreasonable. Therefore, such a feature is inappropriate for use in machine learning for detecting processes with abnormal transitions (i.e., paths in which the state transitions are semantically unreasonable).

In addition, the occurrence frequency of a path decreases as the number of transitions in the path increases. However, a large number of transitions in a path does not always indicate that the path is semantically unreasonable. If all such paths are used as features, the number of features increases. An increase in the number of features increases the time needed for the model generation in machine learning and the inference using the model. In addition, if the number of features is too large, the accuracy of the generated model decreases due to overfitting or another.

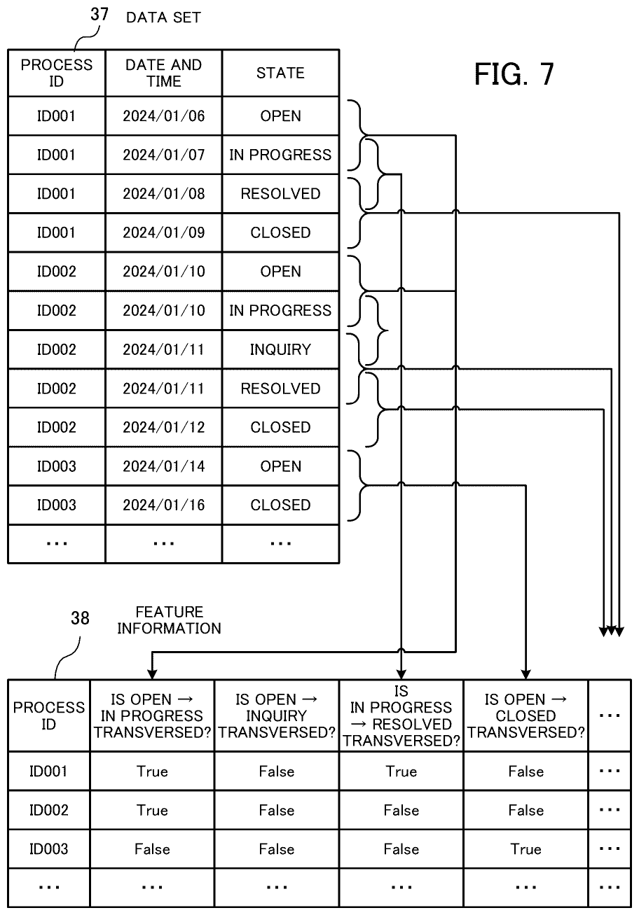

FIG. 7 illustrates a second example of a method of automatically generating features for each process. All possible patterns of a state transition are extracted from the state values included in a data set 37, and each possible pattern corresponds to a column in feature information 38. In the feature information 38, information indicating whether the pattern set as an item is included in the path of a process is set as a feature of the process in association with the process ID of the process. For example, with respect to a process whose path includes the state transition of the pattern set as an item, “True” is set for the item. With respect to a process whose path does not include the state transition of the pattern set as an item, “False” is set for the item.

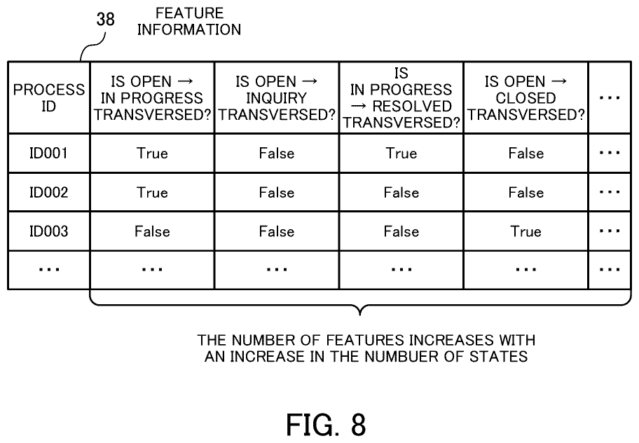

FIG. 8 illustrates an example of a problem that would occur in the case where information indicating whether a path traverses a pattern is used as a feature. In the case where information indicating whether a path traverses a pattern is used as a feature, the number of feature items set in the feature information 38 increases as the number of states increases. If the number of features is too large, overfitting is more likely to occur in the model generation of machine learning. In addition, if the number of features is too large, the processing load of the model generation in machine learning also becomes excessive.

As described above, in the machine learning using a data set relating to state transition processes, it is inappropriate to use either the information indicating whether the frequency of a path is exceptional as a feature or the information indicating whether a path traverses a pattern as a feature. It is difficult to unambiguously determine what kind of information to use as features.

Therefore, in the machine learning system 100 according to the second embodiment, large language models (LLM) are used to interpret the characteristics of a data set, and determines information useful as features from the data set. In the following description, it is assumed that the LLM includes a language model trained by deep learning using a neural network and an inference function using the language model.

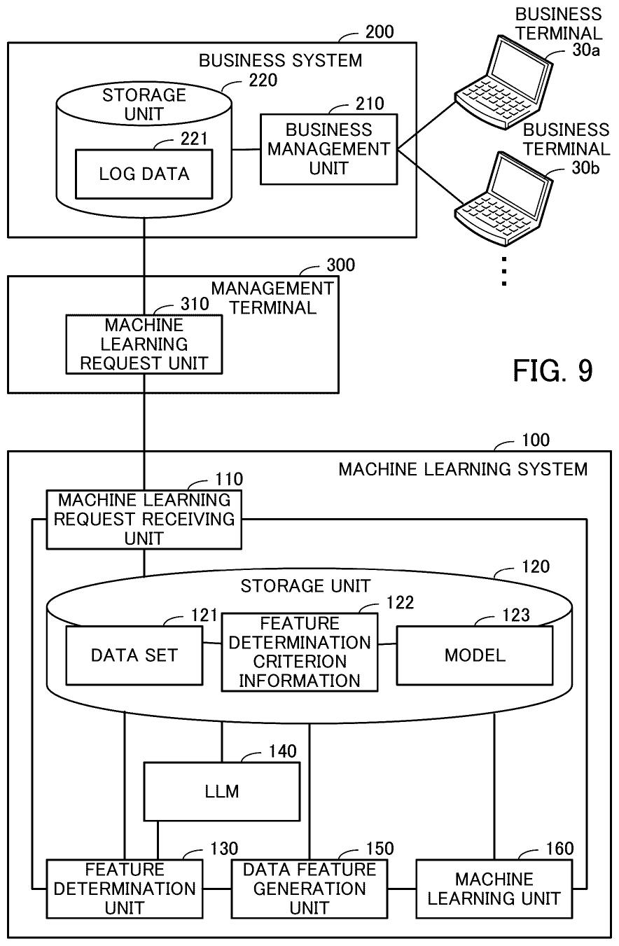

FIG. 9 is a block diagram illustrating an example of functions for performing machine learning relating to state transition processes. The business system 200 includes a business management unit 210 and a storage unit 220. The business management unit 210 manages the execution of tasks using the business terminals 30a, 30b, . . . , and every time the process of a task enters a new state, records information indicating the new state in log data 221. The storage unit 220 stores the log data 221.

The management terminal 300 includes a machine learning request unit 310. The machine learning request unit 310 transmits a machine learning request using the log data 221 to the machine learning system 100 in accordance with an instruction from a user who is an operation manager. For example, the machine learning request unit 310 acquires at least part of the log data 221 from the business system 200 and generates a data set 121 for machine learning. Then, the machine learning request unit 310 transmits a machine learning request including the data set 121 to the machine learning system 100. Examples of the machine learning request include an instruction to generate a model and an instruction to perform inference using a model.

The machine learning system 100 includes a machine learning request receiving unit 110, a storage unit 120, a feature determination unit 130, an LLM 140, a data feature generation unit 150, and a machine learning unit 160.

The machine learning request receiving unit 110 receives a machine learning request from the management terminal 300. The machine learning request receiving unit 110 stores the data set 121 included in the machine learning request in the storage unit 120. The machine learning request receiving unit 110 transmits a feature determination request based on the data set 121 to the feature determination unit 130. When receiving a processing result of the machine learning from the machine learning unit 160, the machine learning request receiving unit 110 transmits the received processing result to the management terminal 300.

The storage unit 120 stores the data set 121, feature determination criterion information 122, and a model 123. The data set 121 is information that contains state transitions of processes over a predetermined period. The feature determination criterion information 122 is information that indicates which state transition information to use as features among the state transitions of the processes indicated in the data set 121. The model 123 is a machine learning model generated through training based on the data set 121.

The feature determination unit 130 determines information to be extracted as features from the data set 121, in accordance with the feature determination request. For example, the feature determination unit 130 conducts dialogues with the LLM 140 using natural language sentences and generates the feature determination criterion information 122 that defines feature determination criteria. The feature determination unit 130 stores the generated feature determination criterion information 122 in the storage unit 120.

When the generation of the feature determination criterion information 122 is complete, the feature determination unit 130 instructs the data feature generation unit 150 to generate features. Note that, in the case where the model 123 has already been trained and the feature determination criterion information 122 for the data set 121 to be used for the model has been generated, the feature determination unit 130 instructs the data feature generation unit 150 to generate features without generating new feature determination criterion information 122.

The LLM 140 interprets the content of sentences represented as character strings in a query, and generates a response in the form of sentences to the query. For example, the LLM 140 interprets the state transitions of each process indicated in the data set 121 and identifies patterns of state transitions representing characteristics of processes that may cause problems. Then, the LLM 140 transmits the identified patterns and the reasons for identifying these patterns to the feature determination unit 130. The LLM 140 is an example of the dialogue system 2 illustrated in FIG. 1.

The data feature generation unit 150 extracts the features of the processes from the data set 121 in response to the feature generation instruction. In this connection, the data feature generation unit 150 determines what patterns of state transitions to use as the features, on the basis of the feature determination criterion information 122. The data feature generation unit 150 transmits feature: information indicating the extracted features to the machine learning unit 160.

In the case where the machine learning request includes a model generation instruction, the machine learning unit 160 generates the machine learning model 123 based on the feature information. The machine learning unit 160 then stores the generated model 123 in the storage unit 120.

In the case where the machine learning request includes an instruction to perform an inference process, the machine learning unit 160 performs the inference process by inputting the feature information to the model 123. For example, the machine learning unit 160 detects processes that need attention, among the processes indicated in the data set 121. The machine learning unit 160 transmits the machine learning result to the machine learning request receiving unit 110.

The function of each element illustrated in FIG. 9 may be implemented by causing the processor 101 to execute a program module corresponding to the element, for example.

With the above system, it is possible to generate a model for machine learning targeting state transition processes and perform an inference process using the model. What kind of information is to be extracted as features from the state transition processes is determined through dialogues with the LLM 140.

For example, the feature determination unit 130 causes the LLM 140 to list semantically reasonable state transition patterns and the reasons. Then, the feature determination unit 130 sets, as features of each process, information indicating whether the process includes each pattern listed by the LLM 140.

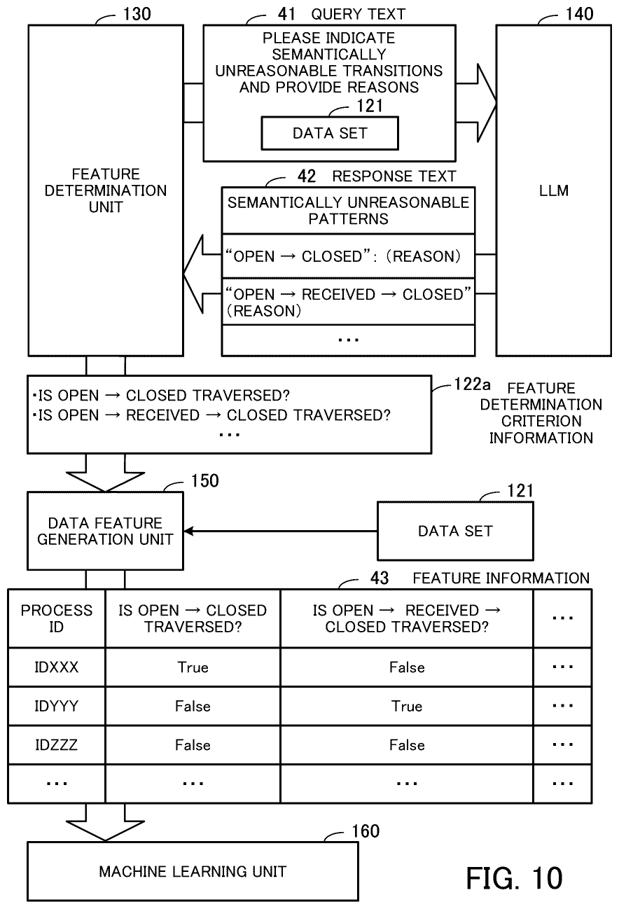

FIG. 10 illustrates an example of a method of generating feature information to be used in machine learning targeting state transition processes. For example, the feature determination unit 130 inputs the character string of a query text 41 to the LLM 140. For example, the query text 41 includes the data set 121 together with a sentence “please indicate semantically unreasonable transitions and provide reasons”. At this time, the feature determination unit 130 may include, in the query text 41, a description of the data set 121, an explanation of a machine learning problem to be solved, and statistical values or metadata obtained from the data set 121. The feature determination unit 130 may input, for example, the following sentences enclosed in the quotation marks to the LLM 140. “• This data set records the lifecycles of inquiries that occur in call center operations.
We would like to estimate the expected durations for future inquiries to be resolved, using machine learning on the basis of the current data set.
The following five states are possible in the data set: “Open, In Progress, Inquiry, Resolved, Closed”.
The most frequent path in the data set is: “Open→In Progress→Resolved→Closed”.
The path with the longest duration from the start to the end in the data set is: “Open→In Progress→Inquiry→In Progress→Inquiry→In Progress→Resolved→Closed”.
Please indicate semantically unreasonable transitions and provide the reasons.”

The LLM 140 interprets the sentences indicated in the query text 41 and generates a response text 42. The response text 42 indicates semantically unreasonable patterns and the reasons. The LLM 140 transmits the generated response text 42 to the feature determination unit 130. The response text 42 includes semantically unreasonable patterns such as “Open→Closed” and “Open→Received→Closed”.

The feature determination unit 130 generates feature determination criterion information 122a indicating the semantically unreasonable patterns indicated in the response text 42. For example, the feature determination criterion information 122a indicates feature determination criteria, such as “is Open→Received traversed?” and “is Open→Received→Closed traversed”. The feature determination unit 130 transmits the feature determination criterion information 122a to the data feature generation unit 150.

The data feature generation unit 150 checks the path of each process in the data set 121. Then, the data feature generation unit 150 determines, for each process, whether the process meets each feature determination criterion, indicated in the feature determination criterion information 122a. The data feature generation unit 150 generates feature information 43 indicating the determination result. In the feature information 43, for the process ID of each process and each feature determination criterion, a feature “True” is set if the process meets the determination criterion, and a feature “False” is set if the process does not meet the determination criterion. The data feature generation unit 150 transmits the generated feature information 43 to the machine learning unit 160.

The machine learning unit 160 performs a machine learning process based on the acquired feature information 43. For example, the machine learning unit 160 generates the model 123.

In the case where the response text 42 obtained from the LLM 140 includes a plurality of semantically unreasonable patterns, the feature determination unit 130 cause the LLM 140 to classify the semantically may unreasonable patterns into categories based on the corresponding reasons provided. Alternatively, the feature determination unit 130 may perform clustering on the basis of the sentences provided by the LLM 140 to classify the semantically unreasonable patterns into categories. By classifying the semantically unreasonable patterns into categories, it becomes possible to treat patterns with similar reasons as a unified feature.

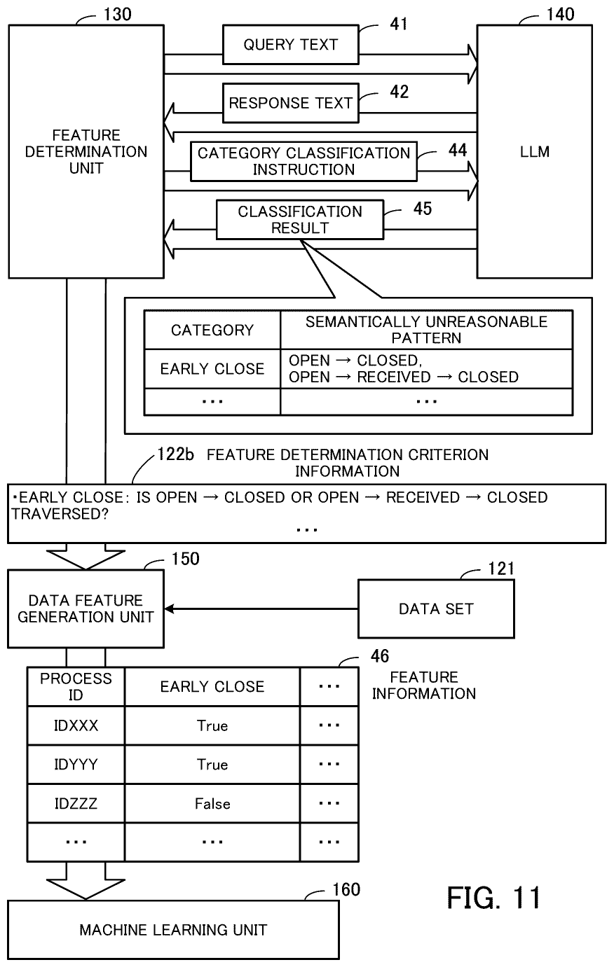

FIG. 11 illustrates an example of category classification of semantically unreasonable patterns. In the case where the response text 42 from the LLM 140 in a response to the query text 41 includes a plurality of patterns, the feature determination unit 130 transmits a category classification instruction 44 for the patterns to the LLM 140. In response to the instruction, the LLM 140 classifies the semantically unreasonable patterns indicated in the response text 42, on the basis of the reasons for determining that the patterns are semantically unreasonable. At this time, it is also possible to cause the LLM 140 to generate category names for the resulting categories. The LLM 140 transmits a classification result 45 to the feature determination unit 130.

In the classification result 45, for example, for each category, semantically unreasonable patterns included in the category are set in association with the category name. In the example of FIG. 11, the patterns “Open→Closed” and “Open→Received→Closed” are set in a category “Early Close”.

The feature determination unit 130 generates feature determination criterion information 122b based on the classification result 45. For example, the feature determination criterion information 122b indicates a feature determination criterion such as “is Open→Closed or Open→Received→Closed traversed” for the Early Close category. Then, the feature determination unit 130 transmits the generated feature determination criterion information 122b to the data feature generation unit 150.

The data feature generation unit 150 checks the path of each process in the data set 121. Then, the data feature generation unit 150 determines, for each process, whether s meets the feature determination criterion for each category indicated in the feature determination criterion information 122b. The data feature generation unit 150 generates feature information 46 indicating the determination result. In the feature information 46, for the process ID of each process and each category, a feature “True” is set if the process meets the determination criterion for the category, and a feature “False” is set if the process does not meet the determination criterion. The data feature generation unit 150 transmits the generated feature information 46 to the machine learning unit 160.

The machine learning unit 160 performs the machine learning process based on the acquired feature information 46. For example, the machine learning unit 160 generates the model 123. For example, the machine learning unit 160 generates the model 123 that detects processes that need attention.

In the feature information 46, each feature corresponds to a category. In the case where two patterns “Open→Closed” and “Open→Received→Closed” are presented by the LLM 140, they are collectively handled as a single feature as the “Early Close” pattern. That is, it is possible to generate a feature in which patterns of state transitions the order of which is semantically unreasonable for similar reasons are unified. As a result, the number of feature types is reduced, compared to the case where the category classification is not performed.

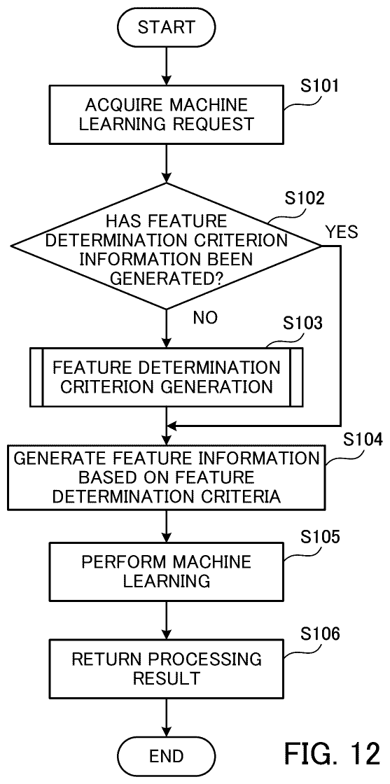

FIG. 12 is a flowchart illustrating an example procedure for the machine learning process. Hereinafter, the process of FIG. 12 will be described in order of step numbers.

[Step S101] The machine learning request receiving unit 110 acquires a machine learning request from the management terminal 300. The machine learning request includes the data set 121. The machine learning request also specifies whether the machine learning request is to request the execution of a learning phase for generating the model 123 using the data set 121 or the execution of an inference phase for performing prediction or classification using the generated model 123.

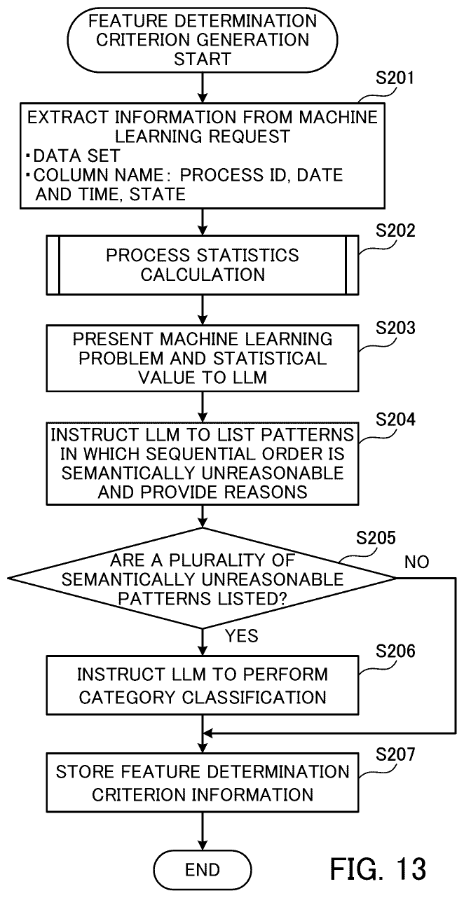

In addition, the machine learning request specifies the column name of a column in the data set 121, which contains information to be used as a feature for state transition processes. The machine learning request further includes information such as a description of the data set 121 and the purpose of the machine learning. The machine learning request receiving unit 110 transmits the acquired machine learning request to the feature determination unit 130.

[Step S102] The feature determination unit 130 determines whether the feature determination criterion information 122 to be used for performing the machine learning in response to the machine learning request has been generated. For example, in the case where the model 123 has been generated, the feature determination criterion information 122 that is used in the generation of the model 123 has also been generated. If the feature determination criterion information 122 has been generated, the feature determination unit 130 advances the process to step S104. If the feature determination criterion information 122 has not been generated, the feature determination unit 130 advances the process to step S103.

[Step S103] The feature determination unit 130 performs a feature determination criterion generation process. The details of the feature determination criterion generation process will be described later (see FIG. 13).

[Step S104] The data feature generation unit 150 generates feature information indicating the features of each process indicated in the data set 121, on the basis of the feature determination criteria indicated in the feature determination criterion information 122. The data feature generation unit 150 transmits the generated feature information to the machine learning unit 160.

[Step S105] The machine learning unit 160 performs the machine learning process requested in the machine learning request, based on the feature information generated from the data set 121. For example, in the case where the execution of the learning phase is requested, the machine learning unit 160 generates the model 123 on the basis of the feature information. In the case where the execution of the inference phase is requested, the machine learning unit 160 calculates an output of the trained model 123 by inputting the feature information into the model 123. The machine learning unit 160 transmits the result of the machine learning process to the machine learning request receiving unit 110. For example, in the case where the machine learning unit 160 newly generates the model 123, the machine learning unit 160 transmits information indicating the completion of the generation to the machine learning request receiving unit 110 as a processing result. In the case where the machine learning unit 160 performs the prediction or classification process using the model 123, the machine learning unit 160 transmits information indicating the prediction result or classification result to the machine learning request receiving unit 110 as a processing result.

[Step S106] The machine learning request receiving unit 110 transmits the processing result to the management terminal 300.

In this way, in the machine learning system 100, appropriate features are extracted from the data set 121, and machine learning using the features is performed. Next, the feature determination criterion generation process will be described in detail.

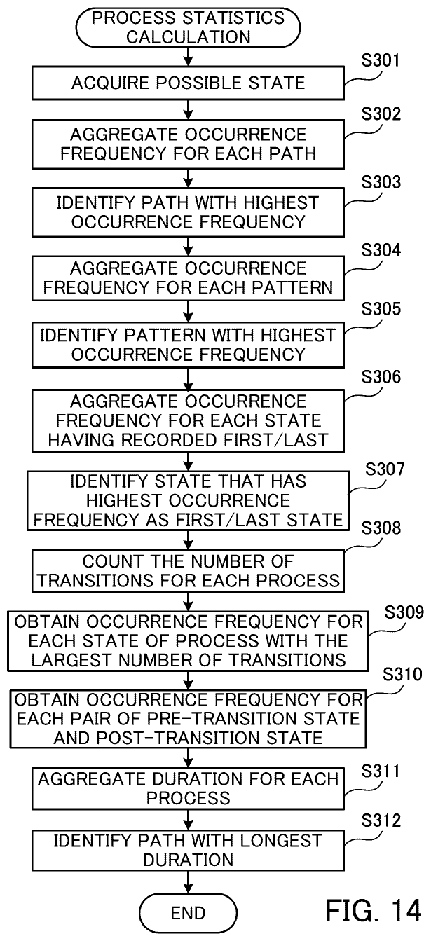

FIG. 13 is a flowchart illustrating an example procedure for the feature determination criterion generation process. Hereinafter, the process of FIG. 13 will be described in order of step numbers.

[Step S201] The feature determination unit 130 extracts information to be used for a machine learning process from the machine learning request. For example, the feature determination unit 130 extracts, from the machine learning request, the data set 121, information such as the column names that of columns contain information representing the state transitions of processes. For example, the feature determination unit 130 extracts process ID, date and time, and state as the column names of columns that contain information representing the state transitions of processes.

[Step S202] The feature determination unit 130 performs a process statistics calculation process. The details of the process statistics calculation process will be described later (see FIG. 14).

[Step S203] The feature determination unit 130 presents the machine learning problem and the statistical value obtained in step S202 to the LLM 140.

[Step S204] The feature determination unit 130 instructs the LLM 140, via a query text, to list patterns in which the sequential relationship of states is semantically unreasonable and provide the reasons. The LLM 140 responds with semantically unreasonable patterns and the reasons.

[Step S205] The feature determination unit 130 determines whether a plurality of semantically unreasonable patterns are listed. If a plurality of semantically unreasonable patterns are listed, the feature determination unit 130 advances the process to step S206. If only one semantically unreasonable pattern is listed, the feature determination unit 130 advances the process to step S207.

[Step S206] The feature determination unit 130 instructs the LLM 140 to perform category classification. Then, the feature determination unit 130 acquires the classification result from the LLM 140.

[Step S207] The feature determination unit 130 generates feature determination criterion information and stores the generated feature determination criterion information in the storage unit 120.

In this manner, the LLM 140 is used to generate the feature determination criterion information defining feature determination criteria for extracting, as a feature, whether a process includes a semantically unreasonable pattern. Next, the process statistics calculation process will be described in detail.

FIG. 14 is a flowchart illustrating an example procedure for the process statistics calculation process. Hereinafter, the process of FIG. 14 will be described in order of step numbers.

[Step S301] The feature determination unit 130 acquires a possible state as one of statistical values. For example, in the case where the character string set in the State column in the data set 121 is any one of “Open”, “In Progress”, “Inquiry”, “Resolved”, and “Closed”, the feature determination unit 130 determines that these five states are possible states.

[Step S302] The feature determination unit 130 aggregates the occurrence frequency for each path of state transitions. For example, for each process indicated in the data set 121, the feature determination unit 130 obtains the path of state transitions. Then, the feature determination unit 130 counts, for each different path, the number of processes having the path as the occurrence frequency of the path.

[Step S303] The feature determination unit 130 identifies a path having the highest occurrence frequency, as one of statistical values. The patterns included in the path having the highest occurrence frequency are expected to be semantically reasonable patterns. Therefore, by presenting the path having the highest occurrence frequency to the LLM 140, the LLM 140 is able to easily and accurately determine semantically reasonable patterns. For example, in the case where the path having the highest occurrence frequency is “Open→In Progress→Inquiry→Resolved→Closed”, the LLM 140 to which this path is presented is able to easily determine that patterns such as “Open→In Progress” and “In Progress→Inquiry” are semantically reasonable.

[Step S304] The feature determination unit 130 aggregates the occurrence frequency for each pattern of state transitions. For example, for each process indicated in the data set 121, the feature determination unit 130 obtains all patterns of state transitions. Then, for each different pattern, the feature determination unit 130 counts the number of processes whose paths include the pattern as the occurrence frequency of the pattern.

[Step S305] The feature determination unit 130 identifies a pattern having the highest occurrence frequency, as one of statistical values. The pattern with the highest occurrence frequency is expected to be a semantically reasonable pattern. Therefore, by presenting the pattern having the highest occurrence frequency to the LLM 140, the LLM 140 is able to easily and accurately determine the semantically reasonable pattern.

[Step S306] The feature determination unit 130 checks the first and last recorded states for each process and counts, for each state, how many times the state appears as a first or last recorded state in processes. For example, among 100 processes, the frequency of each possible state having recorded first in a process is obtained as: “Open: 90 times, In Progress: 5 times, Inquiry: 3 times, Resolved: 1 time, Closed: 1 time”. Similarly, the frequency of each possible state having recorded last in a process is also obtained.

[Step S307] The feature determination unit 130 identifies a state that has the highest occurrence frequency as a first or last state in a process, as one of statistical values. By presenting the state that has the highest occurrence frequency as a first or last state in a process to the LLM 140, the LLM 140 is able to easily and appropriately determine whether a pattern having a transition to the state or a pattern having a transition from the state is semantically reasonable.

For example, a pattern in which the state having the highest occurrence frequency as the first state in a process transitions to another state is highly likely to be semantically reasonable, but a pattern in which the state having the highest occurrence frequency as the last state in a process transitions to another state is highly unlikely to be semantically reasonable. Similarly, a pattern that has a transition to the state having the highest occurrence frequency as the first state in a process is highly unlikely to be semantically reasonable, but a pattern that has a transition to the state having the highest occurrence frequency as the last state in a process is highly likely to be semantically reasonable.

[Step S308] The feature determination unit 130 counts the number of state transitions for each process.

[Step S309] The feature determination unit 130 identifies a process with the largest number of transitions, and obtains the occurrence frequency of each state of the process as one of statistical values. For example, it is assumed that the path of a process having the largest number of state transitions is “Open→In Progress→Inquiry→In Progress→Inquiry→In Progress→Inquiry→In Progress→Resolved→Closed”. In this case, the feature determination unit 130 obtains “Open: 1 time, In Progress: 4 times, Inquiry: 3 times, Resolved: 1 time, Closed: 1 time”.

By presenting the occurrence frequency for each state of the process having the largest number of transitions to the LLM 140, the LLM 140 is able to use the presented statistical values as a reference for determining whether a process is semantically reasonable even when the process includes a large number of transitions.

[Step S310] The feature determination unit 130 obtains, for each pair of pre-transition state and post-transition state, the occurrence frequency of the state transition as one of statistical values. As a result, for example, the feature determination unit 130 is able to obtain information indicating that “a state that most frequently follows the “Resolved” state is “Closed”. For example, the feature determination unit 130 presents this statistical value to the LLM 140. The LLM 140 is able to determine, based on the presented statistical value, that the state transition from Resolved to Closed is highly likely to be a semantically reasonable pattern.

[Step S311] The feature determination unit 130 aggregates the duration for each process. The duration for a process is the difference between the earliest date and time and the latest date and time among the dates and times of states associated with the process ID of the process.

[Step S312] The feature determination unit 130 identifies the path of a process with the longest duration as one of statistical values. By presenting the path of the process with the longest duration to the LLM 140, the LLM 140 is able to use the presented statistical value as a reference for determining whether a path is semantically reasonable even when its duration is long.

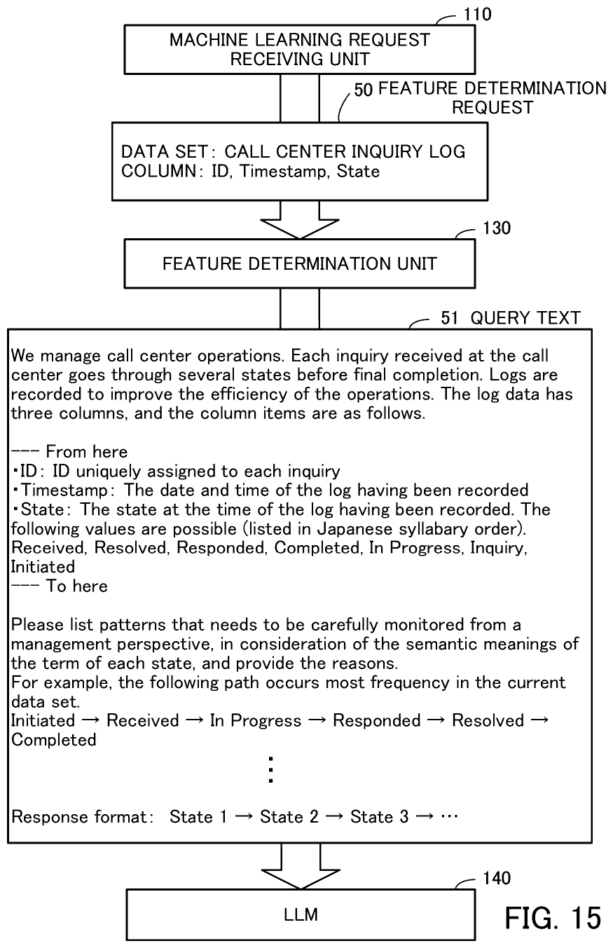

Next, the feature determination process for the data set 121 will be specifically described with reference to FIGS. 15 to 19.

FIG. 15 illustrates an example of a query text based on a feature determination request. For example, a feature determination request 50 specifies that a data set is “call center inquiry log” and that the “ID”, “Timestamp”, and “State” columns represent state transitions of processes in the data set.

The feature determination unit 130 generates a query text 51 to be sent to the LLM 140, on the basis of the feature determination request 50. The query text 51 includes the following sentences enclosed in the quotation marks.

“We manage call center operations. Each inquiry received at the call center goes through several states before final completion. Logs are recorded to improve the efficiency of the operations. The log data has three columns, and the column items are as follows.
From here
ID: ID uniquely assigned to each inquiry.
Timestamp: The date and time of the log having been recorded.
State: The state at the time of the log having been recorded. The following values are possible (listed in Japanese syllabary order).
Received, Resolved, Responded, Completed, In Progress, Inquiry, Initiated
To here
Please list patterns that needs to be carefully monitored from a management perspective, in consideration of the semantic meanings of the term of each state, and provide the reasons.
For example, the following path occurs most frequently in the current dataset.
Initiated→Received→In Progress→Responded→Resolved→Completed
Response format: State 1→State 2→State 3→ . . . ”

The feature determination unit 130 transmits the query text 51 to the LLM 140. Since the data set is the call center inquiry log, the LLM 140 that has acquired the query text 51 recognizes that a process is a task to handle inquiries at the call center and that the states of the process are recorded in the data set. Then, the LLM 140 extracts patterns of state transitions in response to the instruction “Please list patterns that needs to be carefully monitored from a management perspective, in consideration of the semantic meanings of the term of each state, and provide the reasons”. For example, the LLM 140 extracts patterns of state transitions in which pre-transition and post-transition terms are semantically unreasonable, or patterns that each include a state transition that needs attention when the state transition is actually made, even if the terms are semantically reasonable.

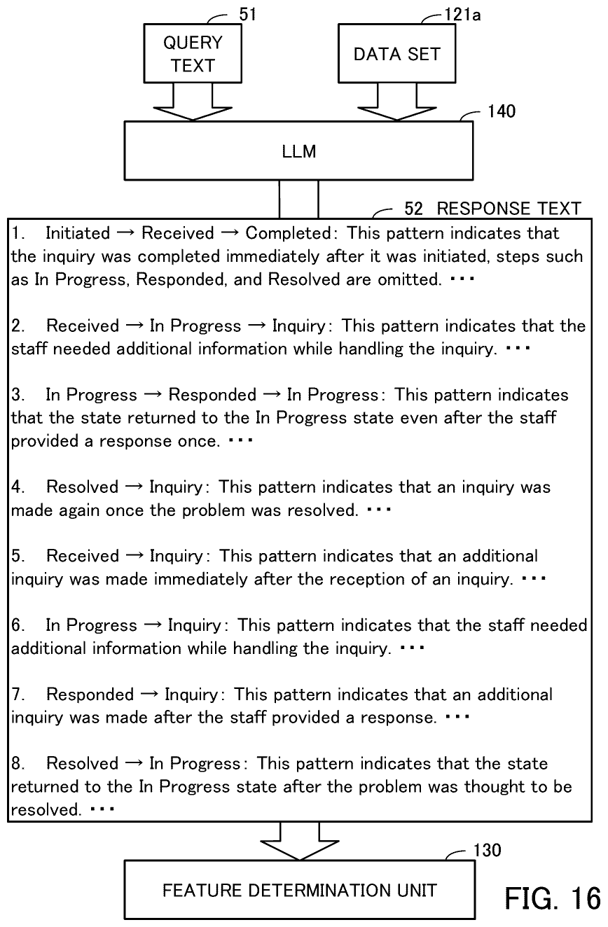

FIG. 16 illustrates an example of a response text. The LLM 140 receives a data set 121a and a query text 51 and outputs a response text 52. The response text 52 from the LLM 140 includes the following sentences enclosed in the quotation marks.

“1. Initiated→Received→Completed: Since this pattern indicates that the inquiry was completed immediately after it was initiated, steps such as In Progress, Responded, and Resolved are omitted. This may occur where the content of an inquiry is simple and may be resolved immediately, or a case where an inquiry is initiated by mistake. However, if this pattern occurs frequently, there may a possibility that the staff tries to close an inquiry early without taking an appropriate action. Therefore, it may be needed to investigate the occurrence frequency and content of this pattern in detail.

2. Received→In Progress→Inquiry: This pattern indicates that the staff needed additional information while handling the inquiry. This occurs when the content of an inquiry is complicated or the staff lacks sufficient knowledge. If this pattern occurs frequently, it may be needed to review the staff training and the information sharing method.

3. In Progress→Responded→In Progress: This pattern indicates that the state returned to the In Progress state again even after the staff provided a response once. This occurs when the staff fails to resolve a problem with the first response or when the customer made an additional inquiry. If this pattern occurs frequently, it may be needed to reassess the problem-solving ability of the staff and the quality of customer service.

4. Resolved→Inquiry: This pattern indicates that an inquiry was made again once the problem was resolved. This occurs when the customer does not understand a solution or a solution is not effective. If this pattern occurs frequently, it may be needed to review how solutions are explained and how the effectiveness is confirmed.

5. Received→Inquiry: This pattern indicates that an additional inquiry was made immediately after the reception of an inquiry. This occurs when the information initially provided by the customer is insufficient or when the staff does not fully understand the content of an inquiry. If this pattern occurs frequently, it may be needed to review how inquiries are received and the inquiry comprehension ability of the staff.

6. In Progress→Inquiry: This pattern indicates that the staff needed additional information while handing the inquiry. This occurs when the content of an inquiry is complicated or the staff lacks sufficient knowledge. If this pattern occurs frequently, it may be needed to review the staff training and the information sharing method.

7. Responded→Inquiry: This pattern indicates that an additional inquiry was made after the staff provided a response. This occurs when the customer does not understand a response or a response does not resolve a problem. If this pattern occurs frequently, it may be needed to review the quality of responses made by the staff and the problem-solving ability of the staff.

8. Resolved→In Progress: This pattern indicates that the state returned to the In Progress state again after the problem was thought to be resolved. This occurs when a solution is not effective or the customer finds an additional problem. If this pattern occurs frequently, it may be needed to review the method for confirming the effectiveness of solutions and the problem-solving ability of the staff”.

The response text 52 presents the eight patterns. For each pattern, the reason for identifying the pattern as a subject to be carefully monitored is provided. For example, with regard to the first pattern “Initiated→Received→Completed”, the omission of steps such as In Progress, Responded, and Resolved is indicated as the reason.

In addition, the response text 52 indicates a presumed cause of each identified pattern. For example, with regard to the first pattern “Initiated→Received→Completed”, the following presumed causes are indicated: a case where the content of the inquiry was simple and was immediately resolved, and a case where the inquiry was initiated by mistake.

Further, the response text 52 presents a point to be aware of and proposed countermeasures for each identified pattern. For example, with regard to the first pattern “Initiated→Received→Completed”, a point to be aware of is a possibility that the staff did not take an appropriate action, and a proposed countermeasure is to investigate the occurrence frequency and content of the pattern in detail.

The response text 52 presents the plurality of patterns. Therefore, the feature determination unit 130 having acquired the response text 52 transmits a category classification instruction to the LLM 140.

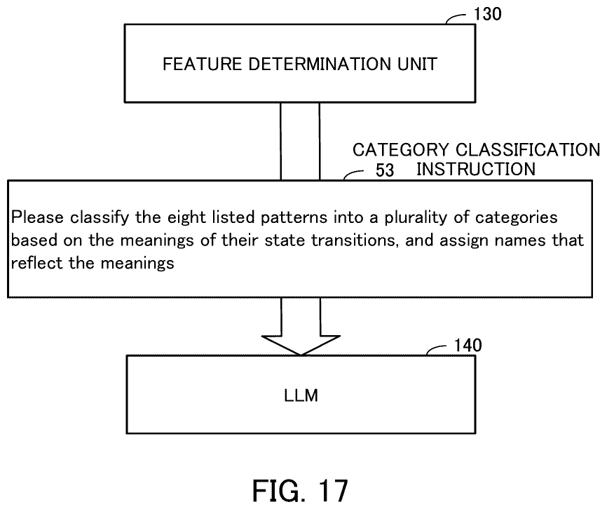

FIG. 17 illustrates an example of a category classification instruction. A category classification instruction 53 includes the following sentences enclosed in the quotation marks.

“Please classify the eight listed patterns into a plurality of categories based on the meanings of their state transitions, and assign names that reflect the meanings.”

The LLM 140, which has received the category classification instruction 53, performs the category classification of the patterns included in the response text 52.

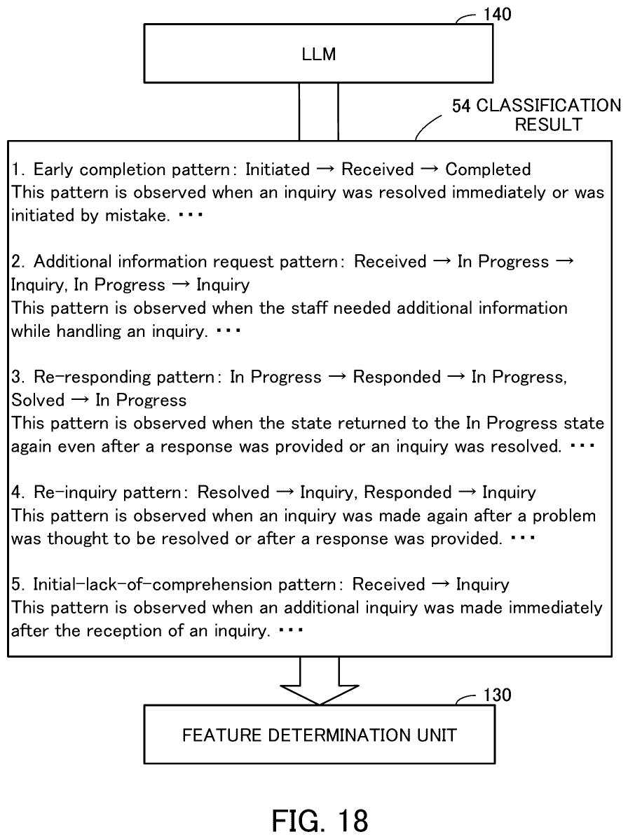

FIG. 18 illustrates an example of a classification result. A classification result 54 includes the following sentences enclosed in the quotation marks.
“1. Early completion pattern: Initiated→Received→Completed
This pattern is observed when an inquiry was resolved immediately or was initiated by mistake. However, if it occurs frequently, there may be a problem with how the staff is handling inquiries.
2. Additional information request pattern: Received→In Progress→Inquiry, In Progress→Inquiry
This pattern is observed when the staff needed additional information handling an inquiry. If it occurs frequently, there may be a problem with the staff training or the information sharing method.
3. Re-responding pattern: In Progress→Responded→In Progress, Resolved→In Progress
This pattern is observed when the state returned to the In Progress state again even after a response was provided or an inquiry was resolved. If it occurs frequently, there may be a problem with the problem-solving ability of the staff or the quality of the customer service.
4. Re-inquiry pattern: Resolved→Inquiry, Responded→Inquiry
This pattern is observed when an inquiry was made again after a problem was thought to be resolved or after a response was provided. If it occurs frequently, there may be a problem with how solutions are explained or how the effectiveness is confirmed or with the quality of responses provided by the staff.
5. Initial-lack-of-comprehension pattern: Received→Inquiry
This pattern is observed when an additional inquiry was made immediately after the reception of an inquiry. If it occurs frequently, there may be a problem with how inquiries are received or with the inquiry comprehension ability of the staff.”

In the classification result 54, for example, a pattern “Received→In Progress→Inquiry” and a pattern “In Progress→Inquiry” are grouped into one category. This category groups together patterns that share the common aspect of the staff having needed additional information.

A category name is assigned to each category indicated in the classification result 54. For example, the category name of the category including the pattern “Received→In Progress→Inquiry” and the pattern “In Progress→Inquiry” is “Additional information request pattern”.

The feature determination unit 130 that has acquired the classification result 54 generates feature determination criterion information.

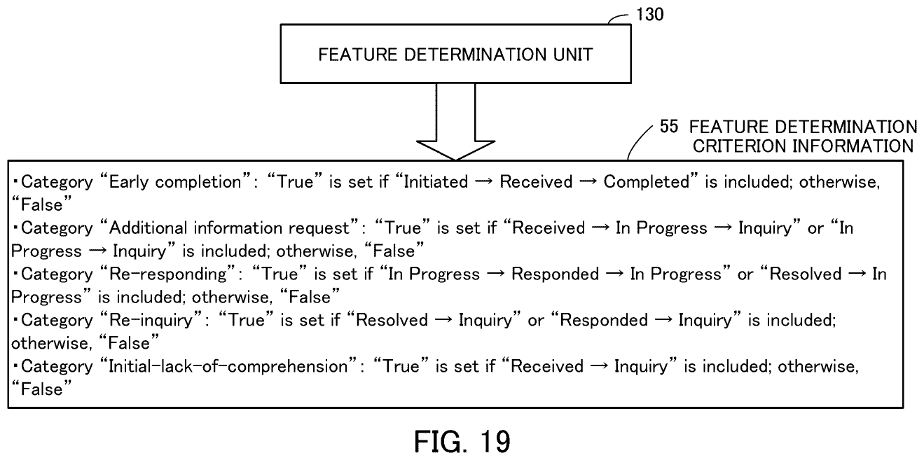

FIG. 19 illustrates an example of feature determination criterion information. Feature determination criterion information 55 indicates a feature determination criterion for each category indicated in the classification result 54. For example, for the category “Early Completion”, a feature “True” is set for a process that includes a pattern “Initiated→Received→Completed”, and a feature “False” is set for a process that does not include this pattern. Based on such feature determination criteria, features for each process are determined from the data set 121a, and feature information is generated.

In the manner described above, through sentence-based dialogues with the LLM 140, it is possible to automatically detect semantically unreasonable state transitions on the basis of terms representing the states of processes and set these state transitions as features for processes. As a result, paths and patterns that have a low occurrence frequency but are semantically reasonable are prevented from being set as features. As a result, an increase in the number of patterns used as features is suppressed.

### Other Embodiments

In the second embodiment, the LLM 140 is provided in the machine learning system 100, but the LLM 140 may be provided on a cloud computing system different from the machine learning system 100.

According to one aspect, it is possible to easily determine appropriate information for use as features of data relating to state transitions.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable storage medium storing a computer program that causes a computer to perform a process comprising:
generating a query text instructing, in natural language, extraction of a first state transition from a data set indicating a series of transitions of states of a plurality of events, the first state transition satisfying a predetermined condition regarding meanings of states before and after a transition;
inputting the query text to a dialogue system, the dialogue system being configured to perform a dialogue in the natural language using a language model, the language model being configured to output a response using a sentence in the natural language in response to a query using a sentence in the natural language; and
determining that, for each event of the plurality of events, information based on whether the first state transition indicated in a response text output by the dialogue system is included in a series of transitions of states of said each event is set as a feature of said each event.

2. The non-transitory computer-readable storage medium according to claim 1, wherein
the generating of the query text includes generating the query text instructing output of the response text including an explanation text of a reason for determining that the first state transition satisfies the predetermined condition, and
the determining includes
classifying, in response to the response text indicating the first state transition in plurality, the plurality of first state transitions into categories based on the explanation text, and
determining that a unified feature is used for two or more second state transitions classified into a same category among the plurality of first state transitions.

3. The non-transitory computer-readable storage medium according to claim 2, wherein the classifying includes inputting an instruction indicating category classification of the plurality of first state transitions to the dialogue system, and acquiring a classification result output by the dialogue system.

4. The non-transitory computer-readable storage medium according to claim 1, wherein the generating of the query text includes generating the query text including a statistical value related to the series of transitions of states of the plurality of events indicated in the data set.

5. The non-transitory computer-readable storage medium according to claim 1, wherein the generating of the query text includes generating the query text instructing extraction of the first state transition that is semantically unreasonable as a normal series of transitions of states for the plurality of events.

6. The non-transitory computer-readable storage medium according to claim 1, wherein the process further includes generating feature information indicating the feature of said each event indicated in the data set, based on the information based on whether the first state transition indicated in the response text output by the dialogue system is included in the series of transitions of states of said each event.

7. An information processing method comprising:
generating, by a processor, a query text instructing, in natural language, extraction of a first state transition from a data set indicating a series of transitions of states of a plurality of events, the first state transition satisfying a predetermined condition regarding meanings of states before and after a transition;
inputting, by the processor, the query text to a dialogue system, the dialogue system being configured to perform a dialogue in the natural language using a language model, the language model being configured to output a response using a sentence in the natural language in response to a query using a sentence in the natural language; and
determining, by the processor, that, for each event of the plurality of events, information based on whether the first state transition indicated in a response text output by the dialogue system is included in a series of transitions of states of said each event is set as a feature of said each event.

8. An information processing apparatus comprising:
a memory; and
a processor coupled to the memory and the processor configured to:
generate a query text instructing, in natural language, extraction of a first state transition from a data set indicating a series of transitions of states of a plurality of events, the first state transition satisfying a predetermined condition regarding meanings of states before and after a transition;
input the query text to a dialogue system, the dialogue system being configured to perform a dialogue in the natural language using a language model, the language model being configured to output a response using a sentence in the natural language in response to a query using a sentence in the natural language; and
determine that, for each event of the plurality of events, information based on whether the first state transition indicated in a response text output by the dialogue system is included in a series of transitions of states of said each event is set as a feature of said each event.
